(19) United States
(12) Patent Application Publication
(10) Pub. No.: US 2008/0063197 A1
(43) Pub. Date: Mar. 13, 2008

(54) Storing encrypted data keys to a tape to allow a transport mechanism

(76) Inventors: Glen A. Jaquette, Tucson, AZ (US); Paul M. Greco, Tucson, AZ (US)

Correspondence Address: HAMILTON & TERRILE, LLP;IBM Tucson, P.O. BOX 203518, AUSTIN, TX, 78720, US

(21) Appl. No.: 11/470,785

(22) Filed: Sep. 7, 2006

(51) Int. Cl. H04N 7/167

(52) U.S. Cl. 380/201

(57) ABSTRACT

A method, system and program are provided for enabling access to encrypted data in a storage cartridge by separately wrapping the data key used to encrypt the data with separate encryption keys (e.g., a public key from a public/private key pair) to form encryption encapsulated data keys (EEDKs) that are stored on the storage cartridge along with the encrypted data. With multiple EEDKs stored on the cartridge, a multi-user transport mechanism is provided where each user can access and decode the encrypted data by retrieving and decrypting an EEDK with a decryption key (e.g., the private key from the public/private key pair) to extract the underlying data key, and then using the extracted data key to decrypt the encrypted data.

### RELATED APPLICATION

This application is related to the following copending and commonly assigned patent applications, each of which is incorporated herein by reference in its entirety: “Distributed Key Store” (Attorney Docket No.: TUC9-2006-0124), “Storing EEDKs to Tape Outside of User Data Area” (Attorney Docket No.: TUC9-2006-0126) and “Method for Altering the Access Characteristics of Encrypted Data” (Attorney Docket No.: TUC9-2006-0128).

### BACKGROUND OF THE INVENTION

1. Field of the Invention

The present invention relates to a method, system, and program for securely providing keys to encode and decode data in a storage cartridge.

2. Description of the Related Art

Protecting and securing data is one of the primary concerns that must be addressed when designing an information management system, whether for a single user, small business or large scale data warehouse. Oftentimes, data may be continually archived on various storage media, such as tape cartridges or optical disks. When archiving data on tape or other removable storage medium, one security concern is that someone will steal the tape and then access the data. Also, if the tape can be mounted into a tape drive through remote commands transmitted over a network, then there is a concern that someone may “hack” into the system, mount the tape or other storage medium in a drive and then access the data.

Prior solutions have addressed some of these problems by encrypting all or most of the data on the storage media, but these approaches have suffered from a number of drawbacks in terms of security weaknesses, implementation challenges and/or unwieldy complexity. For example, with conventional solutions that store the encrypted data on the tape together with the data key used to encrypt the data, anyone having physical access to the tape can retrieve the data key from the tape and use it to decrypt the data. In addition, prior solutions typically allow access to the encrypted data for anyone having the encryption data key, but do not allow different parties to separately access the encrypted data using their own access keys. Conventional encryption systems also maintain the encryption and decryption keys in a central location, and it can be difficult to transfer such encryption keys (which are typically symmetric data keys) using existing key store protocols which are usually designed for storing asymmetric public/private keys. With other data encryption solutions, special drive hardware is required to encrypt and decrypt that tape data using an externally stored encryption key (e.g., the key is stored on the host system and not the tape cartridge). Conventional solutions also fail to address encryption key management between multiple users that require shared access to the same data storage cartridge(s). In view of the foregoing, there is a need in the art for improved protection schemes in a data storage system using removable storage media.

### SUMMARY OF THE INVENTION

A tape cartridge system and method are provided for storing encrypted data and a plurality of encrypted keys on the tape cartridge to provide for tamper resistant data storage. The tape cartridges include a cartridge shell that houses a rewritable medium, such as magnetic tape, and may also include a cartridge memory. In selected embodiments, a data key used to encrypt the data (such as a symmetric AES key) is wrapped in a different key (such as an asymmetric key) using public key cryptography techniques, thereby forming one or more encrypted data keys which may then be securely stored in the tape cartridge so that they need not be retained and somehow associated with the each tape cartridge by the tape driver or host system. In this way, the data key can be wrapped into separate encrypted data keys and stored separately on the tape cartridge so that each wrapped key may be used by a different user.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 illustrates a data storage cartridge with a cartridge memory and a tape medium;

FIG. 2 is a generalized block diagram of a computing environment in which a tape cartridge and tape drive are implemented;

FIG. 3 is a logical flowchart of the steps used to encode and store data;

FIG. 4 is a logical flowchart of the steps used to read and decode stored data;

FIG. 5 illustrates a key storage architecture for storing encrypted data;

FIG. 6 illustrates logic to securely manage keys in the storage architecture of FIG. 5; and

FIG. 7 is a generalized block diagram illustration of the medium format elements of the magnetic tape medium in a tape cartridge.

### DETAILED DESCRIPTION

A method, system and program are disclosed for enabling access to encrypted data in a removable storage medium, such as a tape cartridge, by storing one or more encryption encapsulated data keys (or externally encrypted data keys) (EEDKs) in multiple places in a tape cartridge (such as in the cartridge memory and/or on the tape medium that are designed for holding this type of information). For example, when data is to be encrypted and stored on the removable storage medium, the data is encrypted with a data key, such as by performing an AES encryption with a randomly generated 256-bit data key. The data key may then be encrypted or wrapped with a different encrypting key (a.k.a. key encrypting key) to create an EEDK, such as by using public key cryptography techniques (such as Rivest, Shamir, and Adleman (RSA) or Elliptic Curve Cryptography (ECC)), and the EEDK may be stored in one or more locations in the cartridge memory and/or tape medium of the removable storage medium. In selected embodiments, the data key may be encrypted with different public keys or asymmetric keys to form a plurality of different EEDKs which are stored on the tape cartridge, thereby allowing multiple users to access the underlying data key by using decryption keys that match the encrypting keys used to form the EEDK. By storing a plurality of different EEDKs on a tape cartridge (where each EEDK wraps the same underlying data key with a unique encrypting key), each EEDK can be used by a different user to obtain the underlying data key, so long as the user has the decrypting key that matches the encrypting key. The result is a distributed key store system that permits the encrypted data to be securely transported to separate users. In addition or in the alternative, the EEDK(s) may be separately stored in specially designated areas of the cartridge memory or the tape medium that are outside of the user data areas so that multiple users can access the different EEDKs without altering the user data, so long as the user has the required keys to decrypt the EEDKs.

Various illustrative embodiments of the present invention will now be described in detail with reference to the accompanying figures. It will be understood that the flowchart illustrations and/or block diagrams described herein can be implemented in whole or in part by dedicated hardware circuits, firmware and/or computer program instructions which are provided to a processor of a general purpose computer, special purpose computer, or other programmable data processing apparatus to produce a machine, such that the instructions (which execute via the processor of the computer or other programmable data processing apparatus) implement the functions/acts specified in the flowchart and/or block diagram block or blocks. In addition, while various details are set forth in the following description, it will be appreciated that the present invention may be practiced without these specific details, and that numerous implementation-specific decisions may be made to the invention described herein to achieve the device designer's specific goals, such as compliance with technology or design-related constraints, which will vary from one implementation to another. While such a development effort might be complex and time-consuming, it would nevertheless be a routine undertaking for those of ordinary skill in the art having the benefit of this disclosure. For example, selected aspects are shown in block diagram form, rather than in detail, in order to avoid limiting or obscuring the present invention. In addition, some portions of the detailed descriptions provided herein are presented in terms of algorithms or operations on data within a computer memory. Such descriptions and representations are used by those skilled in the art to describe and convey the substance of their work to others skilled in the art. Various illustrative embodiments of the present invention will now be described in detail below with reference to the figures.

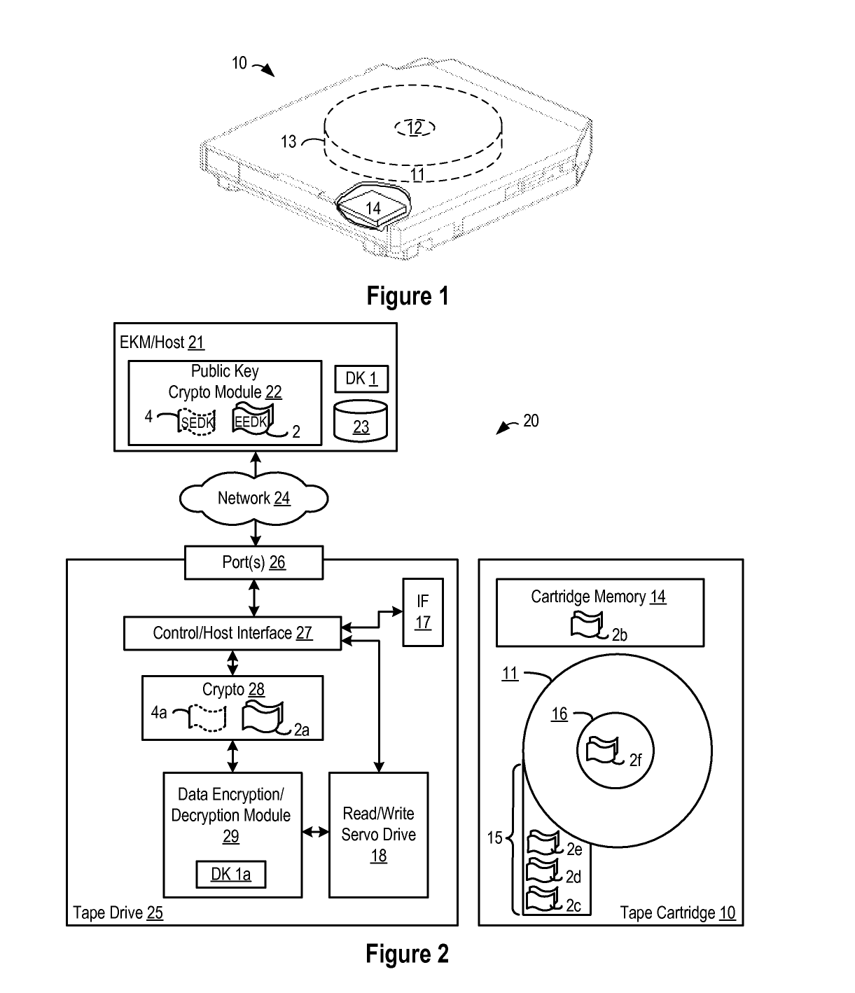

Referring to FIG. 1, a data storage cartridge 10 is illustrated which includes a non-volatile read/writable cartridge memory (CM) circuit 14 (shown in cutaway) and a rewritable storage media 11, such as a high capacity single reel of magnetic tape (shown in phantom) wound on a hub 12 of a reel 13. The cartridge memory 14 is a passive storage device that includes a transponder that provides a contactless interface, and is used to hold information about that specific cartridge, the medium in the cartridge, and the data on the medium. Examples of magnetic tape cartridges comprise a cartridge based on LTO (Linear Tape Open) technology, such as the IBM TotalStorage LTO Ultrium Data Cartridge, and a cartridge based on IBM's 3592 technology, such as the IBM 3592 Enterprise Tape Cartridge. As will be appreciated, the tape cartridge 10 may be a magnetic tape cartridge having dual reel cartridges (in which the tape is fed between reels within the cartridge) or single reel cartridges, such as illustrated in FIG. 1, in which the media 11 is wound on a reel 13 within the cartridge 10. For example, when the cartridge 10 is loaded, the tape is fed between the cartridge reel and a take up reel (not shown). While exemplary tape cartridges based on the LTO and 3592 formats have been described, it will be appreciated that the description is not limited by tape format. Examples of other tape formats include DLT, SDLT, 9840, 9940, T100000, AIT and the like. Additionally, while the description provided herein is with reference to magnetic tape cartridges, it will be appreciated that data storage cartridges may be implemented with magnetic tape, optical tape, optical or magnetic disk, or other forms of rewritable storage media. Likewise, some tape formats do not include cartridge memories (e.g., 3590), while others have a cartridge memory requiring contact (e.g., AIT).

Referring to FIG. 2, a computing environment is illustrated in which a tape cartridge 10 and tape drive 25 are implemented in combination with an external key manager (EKM) 21 as a cartridge handling system 20. It will be appreciated that the external key manager may be a host computer (acting alone or in combination with a proxy control unit), a key management appliance (acting alone or in combination with a proxy library), or the like. One example implementation of such a cartridge handling system 20 would be a magnetic tape data storage system formed from the combination of an IBM 3592 Model E05 Encrypting Tape Drive and the IBM 3592 Enterprise Tape Cartridge subsystem.

In the illustrated example, the EKM/host system 21 includes a host application (not shown), such as a backup program, that transfers data to the tape drive 25 to sequentially write to the tape cartridge 10, such as by using the Small Computer System Interface (SCSI) tape commands to communicate I/O requests to the tape drive 25, or any other data access command protocol known in the art. As will be appreciated, the EKM/host system 21 may be constructed from one or more servers (e.g., the EKM may reside on one server and any application which is reading and writing data to the drive may reside on another server). However implemented, the EKM/host 21 includes a data key generator functionality for generating a data key (DK) 1 for use in performing data encryption, though this functionality may also be provided in the drive 25 or even externally to the system 20. The EKM/host 21 also includes a public key crypto module 22 that is used to form a session encrypted data key (SEDK) 4 from the data key 1, and then to securely pass the SEDK 4 to the tape drive 25 as part of a secure key exchange. The public key crypto module 22 also securely encrypts the data key 1 to form one or more encryption encapsulated data keys (EEDK) 2 (as indicated by the stacked keys). In various embodiments, the public key crypto module 22 uses a predetermined public key encryption technique (such as RSA or ECC) to generate EEDK(s) 2 from DK(s) 1. For example, the public part of a public/private key pair that is retrieved from a key store 23 (which may or may not reside locally with EKM/host 21) may be used to wrap the data key 1 into its encrypted EEDK form. The encrypted EEDK form includes not only the encrypted data key DK itself, but also other structural information, such as a key label or key hash, which identifies the public/private key pair that is used to wrap the data key 1. Once a public key from the key store 23 is used to generate an EEDK, the identifying structural information in the EEDK 2 can be later used by the key module 22 or EKM 21 as an index or reference to the public/private key pair in the key store 23 to retrieve the private key from the key store 23 when the EEDK 2 needs to be processed to unwrap the DK 1.

The tape drive 25 may connect with the host 21 through a direct interface (such as an SCSI, Fibre Channel (FCP), etc., in the case if the tape drive 25 is connected to the host 21) or may connect over a data channel or network 24 (such as a Local Area Network (LAN), Storage Area Network (SAN), Wide Area Network (WAN), the Internet, an Intranet, etc.). It will be appreciated that the tape drive 25 may be enclosed within the host system 21 or may be a standalone unit or in a tape library system (not shown), which may include one or more tape drives, one or more storage units to store multiple tape cartridges, and a mechanical system (commonly referred to as an accessor) to transfer the tape cartridges between the storage unit(s) and the tape drive(s). As illustrated, the tape drive 25 includes a memory circuit interface 17 for reading information from, and writing information to, the cartridge memory 14 of the data storage cartridge 10 in a contactless manner. In addition, a read/write servo drive system 18 is provided for reading information from, and writing information to, the rewritable tape media 11. The read/write servo drive system 18 controls the movement of a servo head (not shown) relative to the magnetic tape medium 11 by moving the magnetic tape medium 11 across the servo head at a desired velocity, and stops, starts and reverses the direction of movement of the magnetic tape.

A control system (or controller) 27 in the tape drive 25 communicates with the memory interface 17 and the read/write system servo drive 18. To receive commands and exchange information for operating the cartridge handling system 20, the controller 27 also acts as a host interface to communicate over one or more ports 26 with one or more external key management (EKM) subsystems 21 (such as a host computer, library or external key management appliance). In addition, a crypto module 28 and data encryption/decryption module 29 are provided in the tape drive 25 for securely encrypting and storing data to the tape cartridge 10 and for securely retrieving and decrypting data stored on the tape cartridge 10. In operation, the data encryption/decryption module 29 performs the actual data encryption and decryption (such as by using the Advanced Encryption Standard encryption algorithm) using a data key having any desired key length (e.g., 128 or 256-bit data key length), and may also perform other encoding functions, such as data compression and decompression and data buffering. The crypto module 28 controls the data encryption/decryption module 29 by securely exchanging data keys (DKs) 1 using the session encrypted data key (SEDK) 4a which is received from the EKM 21 (where it is originally generated as SEDK 4). At the crypto module 28, the data key 1a is extracted from the SEDK 4a, and is sent to the data encryption/decryption module 29 where it is used to encode/decode the input data stream. In addition, the crypto module 28 assembles, validates, distributes, stores and retrieves one or more associated encryption encapsulated data keys (EEDKs) 2a (where the letter suffix “a” in the reference numeral indicates that the EEDKs 2 and 2a are logically identical, though physically distinct copies). While the modules 28, 29 may be implemented with any desired combination of hardware and/or software, the data encryption/decryption module 29 may be implemented with an ASIC or FPGA circuit, while the crypto module 28 may be implemented with one or more drive firmware modules that include a microprocessor and microcode stored in a code memory.

As described herein, the cartridge handling system 20 performs a variety of functions, including but not limited to, encrypting data to be stored on the cartridge 10 using a data key (such as an AES encryption key); using public key cryptography techniques to wrap the data key with a different key to form one or more encrypted data keys; writing and reading the encrypted data and encrypted data key(s) to and from the tape cartridge media; and decrypting the stored encrypted data with the data key that is obtained by unwrapping the encrypted data key. In this way, the cartridge handling system 20 provides a distributed key store which permits different users to access the encrypted data on a single tape cartridge 10 by generating separate EEDKs using each user's public key to wrap the data key 1. For example, at least a first EEDK 2 is generated for local use by using a public key of the local key manager to wrap the data key 1, and the EEDK 2 is then transferred via the tape drive 25 (where it may be temporarily stored as 2a) for storage on the tape cartridge 10 at one or more predetermined locations, as indicated at 2b, 2c, 2d, 2e and 2f. As a result, the transferred EEDK 2 may be stored in the cartridge memory 14 and/or one or more non-user data areas of the tape media 11, such as a read-in area 15 or an end of tape area 16. Though a single copy of the EEDK may be stored on the tape cartridge 10, security and reliability are enhanced by using one or more non-user areas 15, 16 of the tape 11 to store multiple (e.g., three or more) copies of the EEDK 2, thereby allowing deletion of the EEDKs 2, 2a at the EKM 21 and tape drive 25. Since the only non-volatile copies of the EEDKs are stored within the tape cartridge 10, multiple copies of the EEDKs (2b, 2c, etc) provides multiple ways to access the EEDKs and thus the data key 1 in the cases where one or more copies of the EEDKs cannot be read or otherwise processed due to errors or degraded media or drive conditions.

When a plurality of EEDKs 2 are generated from a single data key 1—such as when a second EEDK is generated for a remote user (e.g., a business partner) by using a public key of the remote user to wrap the data key 1—the plurality of EEDKs 2 are transferred via the tape drive 25 for storage on the tape cartridge 10 at one or more locations (as indicated by the copies of the EEDKs 2b-f that are stored in one or more non-user data areas 15, 16 of the tape media 11 and/or the cartridge memory 14). By storing multiple EEDKs on the tape cartridge 10 in specially designated locations (such as the cartridge memory 14 or outside of the tape's user data area), the tape cartridge 10 can have one EEDK wrapped for local use and another for remote exchange. In theory, any number of different EEDKs could be stored, provided there is storage space for them.

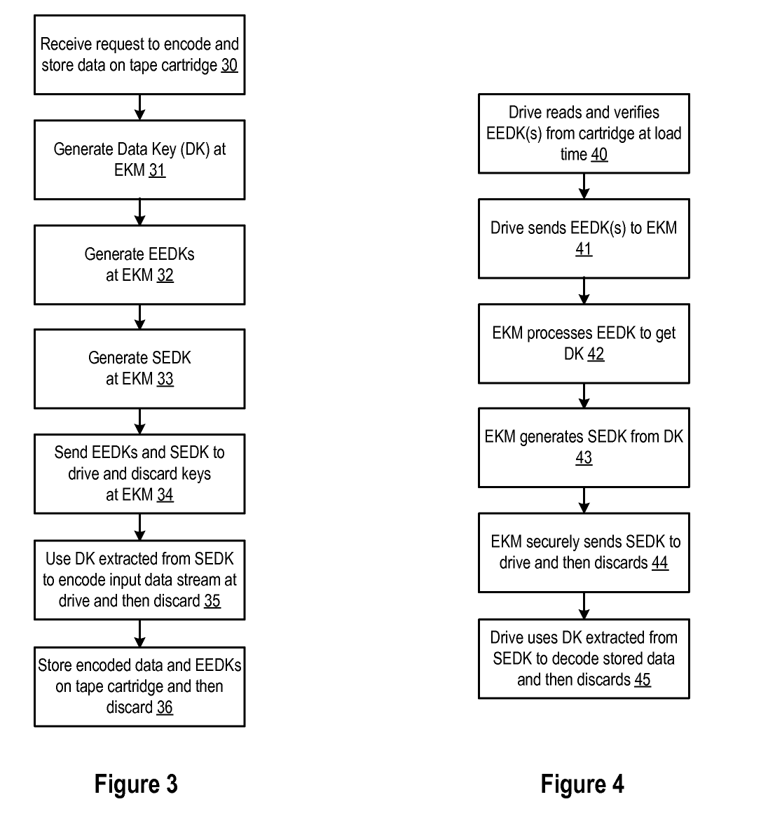

To illustrate how data may be securely encoded and stored on a removable tape cartridge that has not previously acquired its own encrypted data keys, reference is now made to the process flow depicted in FIG. 3 and the cartridge handling system 20 depicted in FIG. 2. When a request is received to encode and store data on the tape cartridge 10 (step 30), a DK 1 is generated at the EKM 21 (step 31) and is then made available in encrypted form to the tape drive 25 before the write process begins. To this end, a secure key exchange is used to transfer the DK 1 in encrypted form to the tape drive 25 for purposes of enabling the tape drive encryption process.

While a variety of different encryption techniques may be used, an initial key generation process at the EKM 21 encrypts the DK 1 to form one or more EEDKs using an encryption method, such as a pubic key cryptographic method (step 32). It is umimportant whether the encryption method is known outside of the EKM. In a selected embodiment, the EEDK creation process in the EKM 21 uses asymmetric encryption by performing RSA 2048-bit encryption of the DK 1 with the public part of a public/private key pair to render the data key 1 within the EEDK 2 completely secure to any entity who does not possess the private part of the key pair. To associate the generated EEDK(s) 2 with the public/private key pair used to encrypt the DK 1, structural information about the public/private key pair is included in each generated EEDK by the EKM 21 which can be extracted from the EEDK for future access to the data key and consequently the encrypted data itself.

At this time, a secure key exchange is established to encrypt the data key DK 1 with a session key (e.g., the public key from the tape drive 25), thereby generating a session encrypted data key 4 (SEDK) (step 33) which can be securely passed, along with the EEDK(s) 2, to the tape drive 25. Once the EKM 21 sends the encrypted data keys to the tape drive 25, the data key 1 and encrypted data key(s) 2, 4 may be discarded by the EKM 21 (step 34). As will be appreciated, there are several methodologies which may be used for secure key exchanges, including wrapping the data key 1 in a session key, though other techniques may be used, including but not limited to RSA, Diffie-Hellman (DH), elliptic curve Diffie Hellman (ECDH), Digital Signature Algorithm (DSA), elliptic curve DSA (ECDSA), etc. The session key may come from the drive or the host.

Upon transfer to the tape drive 25, the EEDK(s) 2a and the SEDK 4a are stored in the crypto module 28. The tape drive 25 decrypts the SEDK 4a with its private session key to produce the data key 1A which is used to set up the encryption hardware module 29. At any point after the encryption hardware module 29 is set up, the SEDK 4a may be discarded from the tape drive (step 35). The tape drive also writes the EEDK(s) 2a to the tape cartridge 10 as part of set up or any point thereafter, and begins encrypting data using the extracted data key 1A. When writing the EEDKs 2a to the tape cartridge 10, the tape drive 25 stores multiple copies of the EEDK 2b-2f in a plurality of locations, such as one or more non-user data areas 15, 16 of tape 11 and in the cartridge memory 14 (step 36). In selected embodiments, the EEDKs are written to the tape cartridge 10 before the encoding or writing of data since such writing may comprise many gigabytes. Also, by recording the EEDKs first, the host system that encounters an error condition can retrieve some portion of the written encoded data by using the previously stored EEDK for that encoded data. While the EEDKs 2a could be discarded from the tape drive after being written to the tape cartridge 10, they may be retained in the tape drive 25 in a volatile fashion for as long as the cartridge is loaded in the drive. Once the input data stream is encrypted and the tape drive 25 has written the encoded data to the tape 11, the tape drive 25 discards the data key 1A (step 36). Once the encoded data and EEDK(s) 2b-2f are stored to the tape cartridge 10, the tape drive 25 discards the encoded data and the EEDK(s) 2a (step 36).

An example of how data may be securely decoded and read from a removable tape cartridge will now be described with reference to the process flow depicted in FIG. 4 and the cartridge handling system 20 depicted in FIG. 2. During the tape cartridge load process, the tape drive 25 recognizes that a tape 11 has encryption data on it by detecting the existence of EEDKs or other control indicators on the tape cartridge 10 (step 40). This may be done at the tape drive 25 by reading the EEDK(s) 2b from cartridge memory 14 and/or by reading and verifying the EEDK(s) 2c-f from a non-user data area(s) 15, 16 of tape 11.

To enable the tape device hardware decryption and/or encryption process(es), a key exchange must occur in order to retrieve and decrypt the stored EEDKs 2b-f for purposes of extracting the correct decryption data key. However, when the data keys are not retained or stored on the tape drive 25 or the EKM 21, the EEDKs 2b-f must be used to reacquire the data key 1 at the EKM 21 which is then securely transferred to the tape drive 25. For example, after the tape cartridge 10 is loaded and the EEDKs 2b-f are stored as EEDKs 2a in the crypto module 28 of the tape drive 25, the tape drive 25 sends the EEDKs 2a to the EKM 21 (step 41), either in response to a request from the EKM 21 (or automatically in the case of a library/appliance model). Once the EEDKs 2 are transferred to the EKM 21, the EKM 21 determines their validity and decrypts the EEDKs 2 by extracting structural information from each EEDK and searching the key store 23 for a match, in which case the associated private key is output from the key store 23 and used to decrypt the EEDK, thereby extracting the data key DK 1 (step 42). The data key DK 1 is then securely wrapped in the driver's session key to generate the session encrypted data key SEDK 4 (step 43). Using any desired secure key exchange protocol, the EKM 21 passes the SEDK 4 to the tape drive 25 where it is stored as the SEDK 4a, at which time the EKM 21 discards the SEDK 4 (step 44). The tape drive 25 then decrypts the SEDK 4a with its private session key to produce the data key 1A which is used to setup the decryption hardware module 29 (step 45). Again, the tape drive 25 can discard the SEDK 4a at any point after the decryption hardware module 29 is setup, even before the stored data is decrypted.

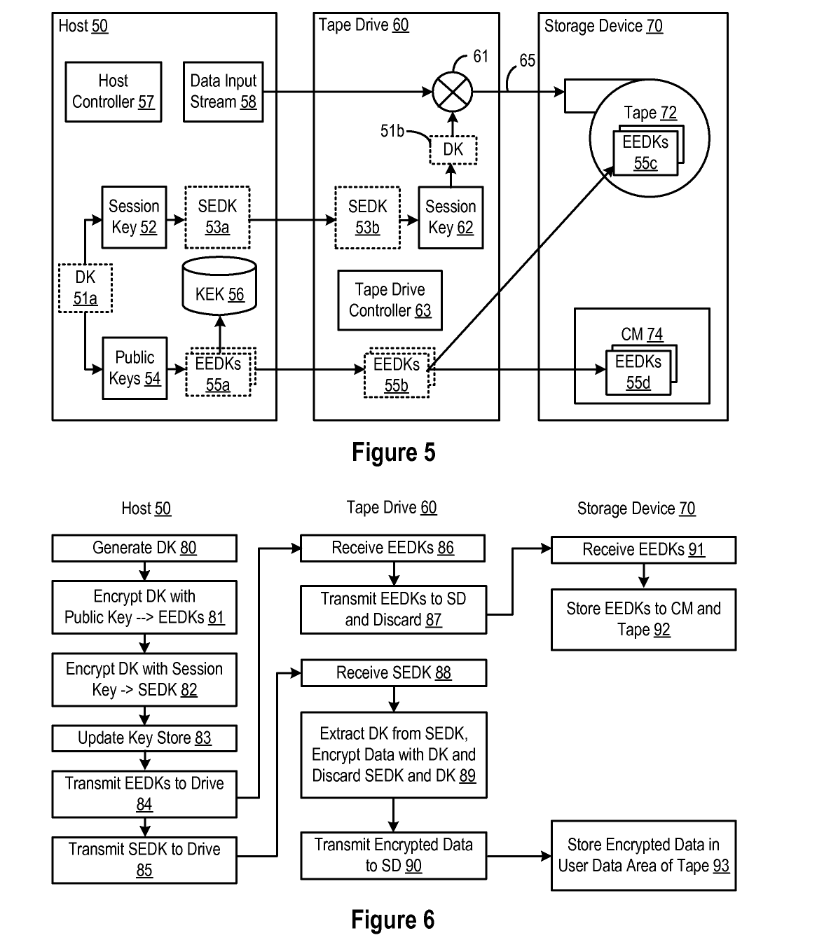

FIG. 5 illustrates a key storage architecture for storing encrypted data to illustrate how the various keys may be deployed in the host 50, tape drive 60 and storage device 70. The host 50 generates a unique data key 51a (e.g., a unique 256-bit AES key) to encode and decode data on at least one storage device. The host 50 also includes a session key 52 that is capable of encrypting data that can be decrypted by a session key 62 at the tape drive 60. For example, the session keys 52, 62 can be generated as a public/private key pair using public key encryption algorithms known in the art. The host 50 further includes one or more public keys 54 that are capable of encrypting the data key 51a into one or more encryption encapsulated data keys (EEDKs) 55a that can be decrypted by the appropriate private key that matches the public key 54. To subsequently extract a data key from the EEDK 55a (upon its subsequent receipt), the generated EEDK 55a includes meta information (such as key label or identifier information relating to the key encrypting key 54) that can be used to reference or lookup the key encrypting key 54 and its corresponding private key in the key store 56 that can be used to decrypt the received EEDK. In addition or in the alternative, the key store 56 stores information identifying the EEDKs generated by the host 51 so that the identifying information is associated (e.g., by using a table) with the public key used by the host to generate the EEDK. Finally, the host 50 includes a host controller 57 that that handles I/O requests for directing a data input stream 58 to the tape drive 60. Once the data key 51a and encrypted data keys 53a, 55a are used, they may be discarded from the host 50, as indicated by the dashed lines in FIG. 5.

At the tape drive 60, the received SEDK 53b is stored and decrypted by the session key 62 to generate a local copy of the data key 51b, all under control of the tape drive controller 63. The data key 51b is then combined in an encryption circuit 61 with the input data stream 58 from the host 50, thereby generating an encrypted data stream 65 that is stored in the tape media 72. In addition, the received EEDKs 55b are forwarded to the storage device 70 where they are collectively stored to one or more locations 55c in the non-user data portion of the tape 72, and/or to predetermined location(s) 55d in the cartridge memory 74. Once the data key 51b and encrypted data keys 53b, 55b are processed at the tape drive 60, they may be discarded, as indicated by the dashed lines.

FIG. 6 illustrates logic to securely manage keys in the storage architecture of FIG. 5 using the control logic implemented in the host controller 57 and tape drive controller 63 for securely managing and storing keys and encrypted data in one or more storage devices. When the host 50 generates a data encryption key DK (block 80), it is encrypted with one or more public keys (e.g., a public key of the host or a business partner) to form one or more key-wrapped data keys (a.k.a. EEDKs) (block 81). In certain implementations, the host 50 obtains the public key from a third party, or alternatively, the host 50 can generate the public/private key pair itself. The host 50 also encrypts the data key with a public session key (e.g., the tape drive's public key) to form a session encrypted data key (SEDK) (block 82). While generally not required, in some embodiments, the key store or related mechanism may be updated to correlate or track the wrapping key(s) used in forming of any EEDK(s) (block 83). The encrypted data keys (EEDKs and SEDK) are transmitted to the tape drive 60 and discarded from the host 50 (blocks 84, 85).

Upon receiving the EEDKs for a storage device 70 (at block 86), the tape drive controller 63 writes (at block 87) the encrypted data keys (EEDKs) to the storage device 70 and then discards the EEDKs. In addition, once the session encrypted data key (SEDK) is received at the tape drive (block 88), the tape drive controller 63 decrypts the SEDK to extract the data key using the tape drive private session key that corresponds to the public session key, and then uses the extracted data key to encode data being written to the storage device (at block 89). After the data is encoded and stored, the data key and SEDK are discarded and the encoded data is transmitted to the storage device 70 (at block 90).

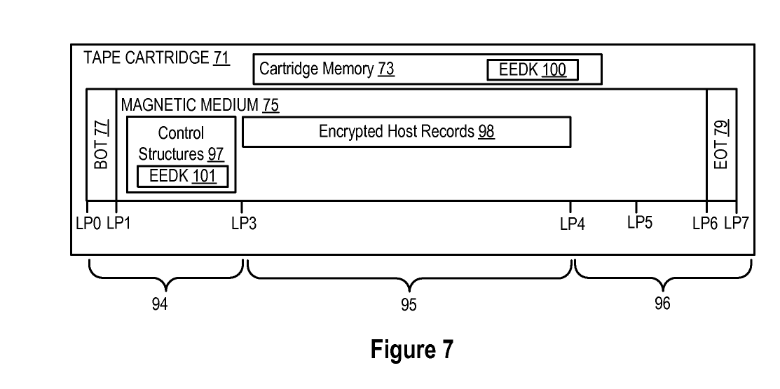

When the EEDKs are received at the storage device (block 91), they are separately stored in multiple locations in the storage device, such as the cartridge memory and the non-user data area of the tape (block 92). In selected embodiments, the EEDKs are written to the storage device 70 prior to storing the encrypted data on the storage device. An example implementation of how EEDKs are stored is depicted in FIG. 7, which depicts a tape cartridge 71 having a cartridge memory 73 and a magnetic tape medium 75 and which shows the medium format elements of the magnetic tape medium 75. With reference to an illustrative implementation in which the tape medium uses an LTO tape format, the length of a magnetic tape 75 is divided into logical points (LPs), which define bounds of regions of the tape. The regions of LP0 to LP1 and LP6 to LP7 are unused as they define the beginning of tape (BOT) region 77 and the end of tape (EOT) region 79, respectively. Additional non-user regions include the region of LP1 to LP2 (which is a servo acquisition area), the region of LP2 to LP3 (which is a calibration area that includes different information in the different bands), and the regions after LP4 (which include the servo acquisition region for reverse wraps). Thus, the magnetic tape 73 layout includes non-user areas 94 and 96. The magnetic tape 73 layout also includes user data regions 95 (between LP3 and LP4) in which the encrypted data 98 is stored. Of course, different tape formats may be used other than LTO formats where such formats provide for user data areas 95 that are separately delineated from non-user data areas 94, 96.

As illustrated in FIG. 7, the EEDKs 100, 101 may be stored in multiple places by using the non-User Area parts of tape cartridge 71 to store the EEDKs. For example, an EEDK 100 may be stored in the cartridge memory 73. In addition, EEDKs may be stored in special non-user data set regions 94, 96 of the tape medium 75 that are designed for holding this type of information, such as the tape regions before the User Data area (i.e. before LP3) or after it (i.e. after LP4). Thus, for each encrypted tape cartridge 71 stored in the tape 75, an internal control storage area 97 is provided which allows the storage of EEDK structures 101 if this structure is provided by the external key manager.

When the EEDKs 100, 101 are stored in non-user areas, the data key wrapping technology described herein may be used to change the access to the encrypted data by changing the access to the encrypted data key without re-encrypting the underlying data, thereby providing a variety of additional cartridge control features, such as adding an EEDK to the cartridge, re-keying a cartridge, shredding a cartridge, and setting a cartridge to persistently unencrypted state. In particular, when the DK is encrypted with a first wrapping key (e.g., a public key from a public/private key pair) to form a first EEDK, additional access to the DK can be provided by separately encrypting the DK with a second wrapping key to form a second EEDK. With this approach, multiple users are able access the encrypted data, and can be added without re-encrypting the data by storing the new EEDK's outside of the user data area of the tape volume. With multiple EEDK structures on the cartridge that are each created using different wrapping keys to wrap the same underlying data key DK, parallel access to the DK (and therefore the data on the tape) is provided to anyone possessing the necessary unwrapping key (e.g., the private key from the public/private key pair) associated with any of the EEDK structures.

Another cartridge control feature is that a cartridge can be re-keyed to change the user access, thereby removing a first user and adding a second user. This may be accomplished by decoding a first EEDK on the cartridge using an appropriate unwrapping key to extract the underlying data key DK, re-wrapping the DK using a different wrapping key (e.g., a new public key from a public/private key pair that belongs to a second user) to generate a new EEDK, and re-storing the new EEDK back on the tape to overwrite the first EEDK. The result is that access is removed for anyone who previously could decode the first EEDK, while enabling access for anyone who could decode the new EEDK, all without having to re-write the data and encrypt it with a different data key.

Yet another cartridge control feature is that cartridge data access can be permanently prevented, effectively “shredding” the cartridge data. This may be accomplished by deleting or erasing the EEDK structures from the tape. Since the EEDK structures are the only repository for the data key needed to decrypt the cartridge data, the data may never be decrypted. Erasing the EEDK structures is much faster (on the order of 2-3 minutes versus 1-2 hours) and actually more secure then erasing all the data from the tape. Another advantage is that the wrapping and unwrapping keys do not need to be deleted from the key store to prevent readability of the tape, since the EEDKs have been deleted. Also, EEDK erasure can be performed more securely (e.g., using multiple erase passes with random patterns), more easily and more quickly then a secure erase of all encrypted data.

A still further cartridge control feature is that the cartridge data can be set to a persistently unencrypted cartridge state. This feature can be useful when there is no longer a need for secure encryption of the cartridge data, thereby enabling all users to access the data as though the data were unencrypted, yet without having to re-write the data without encryption. In this operation, the EEDKs are unwrapped to extract the underlying data key, which is then stored in the clear in the control storage area (that was previously used to store the EEDK structure). As a result, any encrypting drive can access the control storage area and use the clear Data Key without any unwrapping operation so that the encrypted tape is now readable on any encrypting drive with no requirement to hold an unwrapping key. Of course, this process can be reversed by wrapping the data key in a wrapping key to form an EEDK that is re-stored to the control storage area, thus allowing the cartridge access to be limited, if desired (though this may be disallowed in some environments for security reasons).

As will be appreciated by one skilled in the art, the present invention may be embodied in whole or in part as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. For example, the functions of tape drive 25 and tape cartridge 10 may be implemented in software commonly referred to as a virtual tape library. The virtual tape library software may communicate with EKM/host 21 and mimic the functions of a physical tape library, including the functions of reading from and writing to a storage device, such as a tape drive. The virtual tape library software may reside on a separate computer system coupled to EKM/host 21.

The foregoing description has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification and example implementations provide a complete description of the manufacture and use of the composition of the invention. Since many embodiments of the invention can be made without departing from the spirit and scope of the invention, the invention resides in the claims hereinafter appended.

What is claimed is:

1. A method for enabling access by a plurality of users to encrypted data stored on a storage cartridge, comprising:
generating a first data key for encrypting data to form encrypted data;
encrypting the first data key with a first key encrypting key to generate a first encrypted key, where first encrypted key may be decrypted to extract the first data key by a first user using a first decrypting key;
encrypting the first data key with a second key encrypting key to generate a second encrypted key, where second encrypted key may be decrypted to extract the first data key by a second user using a second decrypting key; and
storing the first encrypted key, second encrypted key and encrypted data to the storage cartridge.

2. The method of claim 1, wherein the first data key, first encrypted key and second encrypted key are generated at an external key manager and are subsequently discarded so that the first data key is only recoverable by decryption of the first or second encrypted keys, which are stored only on the storage cartridge.

3. The method of claim 1, where the first key encrypting key and first decrypting key comprise a public key and a private key, respectively, of a public/private key pair.

4. The method of claim 1, where the first data key comprises an AES key.

5. The method of claim 1, where encrypting the first data key comprises using a public key cryptography technique.

6. The method of claim 1, where the first key encrypting key comprises an RSA data key.

7. The method of claim 1, where the first key encrypting key comprises an elliptic curve public key, and the first decrypting key comprises an elliptic curve private key that corresponds to the elliptic curve public key and that the first user can use to decrypt the first encrypted key.

8. The method of claim 1, where the second key encrypting key comprises an RSA public key, and the second decrypting key comprises an RSA private key that corresponds to the RSA public key and that the second user can use to decrypt the second encrypted key.

9. The method of claim 1, where the storage cartridge comprises a cartridge memory and where one or more of the first and second encrypted keys are stored in the cartridge memory.

10. The method of claim 1, where the storage cartridge comprises a storage medium and where the encrypted data and one or more of the first and second encrypted keys are stored in the storage medium.

11. The method of claim 1, where the first key encrypting key comprises an AES key, and the first decrypting key comprises the AES key.

12. The method of claim 1, where the first data key comprises a key for a high speed symmetric encryption algorithm.

13. The method of claim 1, where the first key encrypting key comprises one half of an asymmetric key pair for any form of asymmetric encryption, and the first decrypting key comprises the other half of the asymmetric key pair.

14. The method of claim 1, where the first key encrypting key comprises a key for a symmetric encryption algorithm, and the first decrypting key comprises the same key.

15. A data storage drive comprising:
read/write drive for reading data from and writing data to a storage medium housed in a data storage cartridge loaded in the data storage drive; and
a controller coupled to the read/write drive that is configured to process a session encrypted data key and an associated plurality of encryption encapsulated data keys by:
decrypting the session encrypted data key to extract a data key;
encoding data with the data key to form encoded data;
directing the read/write drive to store the encoded data on the storage medium; and
directing the read/write drive to store the associated plurality of encryption encapsulated data keys on the storage medium.

16. The data storage drive of claim 15, where the associated plurality of encryption encapsulated data keys comprises:
a first encrypted key which is formed by wrapping the data key with a first key encrypting key, where first encrypted key may be decrypted to extract the data key by a first user using a first decrypting key; and
a second encrypted key which is formed by wrapping the data key with a second key encrypting key, where second encrypted key may be decrypted to extract the data key by a second user using a second decrypting key.

17. The data storage drive of claim 15, where the controller is configured to direct the read/write drive to store the associated plurality of encryption encapsulated data keys in a plurality of locations on the storage medium.

18. The data storage drive of claim 17, where the storage medium comprises a cartridge memory housed in the data storage cartridge.

19. The data storage drive of claim 17, where the storage medium comprises a magnetic tape housed in the data storage cartridge and where the controller is configured to direct the read/write drive to store the associated plurality of encryption encapsulated data keys in a plurality of locations on the magnetic tape.

20. The data storage drive of claim 15, where the controller is configured to:
direct the read/write drive to read at least a first encryption encapsulated data key from a data storage cartridge; and
forward the first encryption encapsulated data key to a key manager to be unwrapped with a first decrypting key to extract a data key which can be used at the data storage drive to decode encrypted data stored on the data storage data cartridge.

21. The data storage drive of claim 15, further comprising a data encryption module for encoding data with the data key using AES encryption to form AES encoded data.

22. A storage system for enabling secure access to data in a removable storage cartridge, comprising:
a key manager for generating a data key, wrapping the data key with a plurality of encrypting keys to generate a corresponding plurality of encrypted data keys, and subsequently discarding the data key and the plurality of encrypted data keys;
a tape drive for securely receiving the data key from the key manager and for encoding data with the data key to form encoded data; and
a removable storage cartridge for storing the plurality of encrypted data keys and the encoded data.

23. The storage system of claim 22, where the key manager securely transfers the data key to the tape drive by encrypting the data key with a session key to form a session encrypted key that can be decrypted by the tape drive to extract the data key.

24. The storage system of claim 22, where the key manager uses a public key cryptography technique to wrap the data key with a plurality of encrypting keys to generate a corresponding plurality of encrypted data keys.

25. The storage system of claim 22, where the key manager uses a public key cryptography technique to wrap the data key with the plurality of encrypting keys to generate the corresponding plurality of encrypted data keys that are transferred through the tape drive for storage in the removable storage cartridge.
